(19) United States
(12) Patent Application Publication
(10) Pub. No.: US 2015/0059421 A1
(43) Pub. Date: Mar. 5, 2015

(54) LOCK ARRANGEMENT

(71) Applicant: Abloy Oy, JOENSUU (FI)

(72) Inventors: Veli-Pekka Kyllönen, Kontioniemi (FI); Jari RÄTY, Joensuu (FI)

(21) Appl. No.: 14/467,628

(22) Filed: Aug. 25, 2014

(30) Foreign Application Priority Data
Aug. 29, 2013 (FI) 20135873

(51) Int. Cl. E05B 67/32; E05B 47/00

(52) U.S. Cl. CPC E05B 67/32; E05B 47/00
USPC 70/37; 70/20

(57) ABSTRACT

The object of the invention is to provide a novel padlock, which can be used like a normal padlock and also in objects and situations, for which known padlocks are not suitable. A padlock according to the invention comprises two bodies (1, 3), between which is a shackle portion (2). The shackle portion consists of two pins (2A, 2B). Both bodies are to be locked into the shackle portion. The locking of the padlock can be opened and also locked with the key of one or the other of the bodies. In this case, one key can be a key that is normally in use and the other key is less often used.

### TECHNICAL FIELD

The invention relates to the locking of objects ordinarily locked with a padlock.

### PRIOR ART

It is known to use padlocks to lock a wide variety of objects, such as storages, outboard motors, bicycles, cargo containers, trailers etc. A padlock has a body and a shackle. The shackle is bent such that it forms a loop, which can be locked into the body. The loop (usually shaped like the letter U) can be opened from the locking with the key of the padlock, in order that the locked object can be released. The shackle is normally attached from one end in the body of the padlock, but also such types of shackle exist, in which both ends separate from the lock body, when the locking is opened.

The padlock is a movable lock, which can be moved from one place to another. Movability makes the padlock multi-purpose. Regardless of this, a padlock is not suitable for all objects or situations.

### BRIEF DESCRIPTION OF THE INVENTION

The object of the invention is to provide a novel padlock, which can be used like a normal padlock and also with objects and situations, for which known padlocks are not suitable.

The invention is based on the idea that a padlock according to the invention comprises two bodies, between which is the shackle portion. The shackle portion consists of two pins, so the shackle does not consist of one bar bent into the shape of the letter U. Both bodies are to be locked into the shackle portion. Because both bodies are to be used in a manner known per se with a key for opening and locking the shackle portion into the lock body, the locking of the inventive padlock can be opened and also locked with the key of one or the other of the bodies. In this case, one key can be the key that is normally in use and the other key can be less often used. The less often used key is used, for example, when the key that is normally in use is lost.

A lock arrangement according to the invention comprises then a body portion and a shackle portion. The body portion has two holes for locking the shackle portion into the body portion. The shackle portion comprises two pins, each of which has a first end and a second end. In both of the ends of the pins is a locking groove, and the first ends of the pins are arranged to be locked into the holes of the body portion. The lock arrangement comprises also a second body portion with another two holes, into which the second ends of the pins are arranged to be locked.

### LIST OF FIGURES

In the following, the invention is described in more detail by means of the accompanying figures, in which

FIG. 1 shows an example of a lock arrangement according to the invention,

FIG. 2 shows an example of a lock arrangement according to the invention with the first body in the unlocked position, and

FIG. 3 shows an example of a lock arrangement according to the invention with the second body in the unlocked position.

### DESCRIPTION OF THE INVENTION

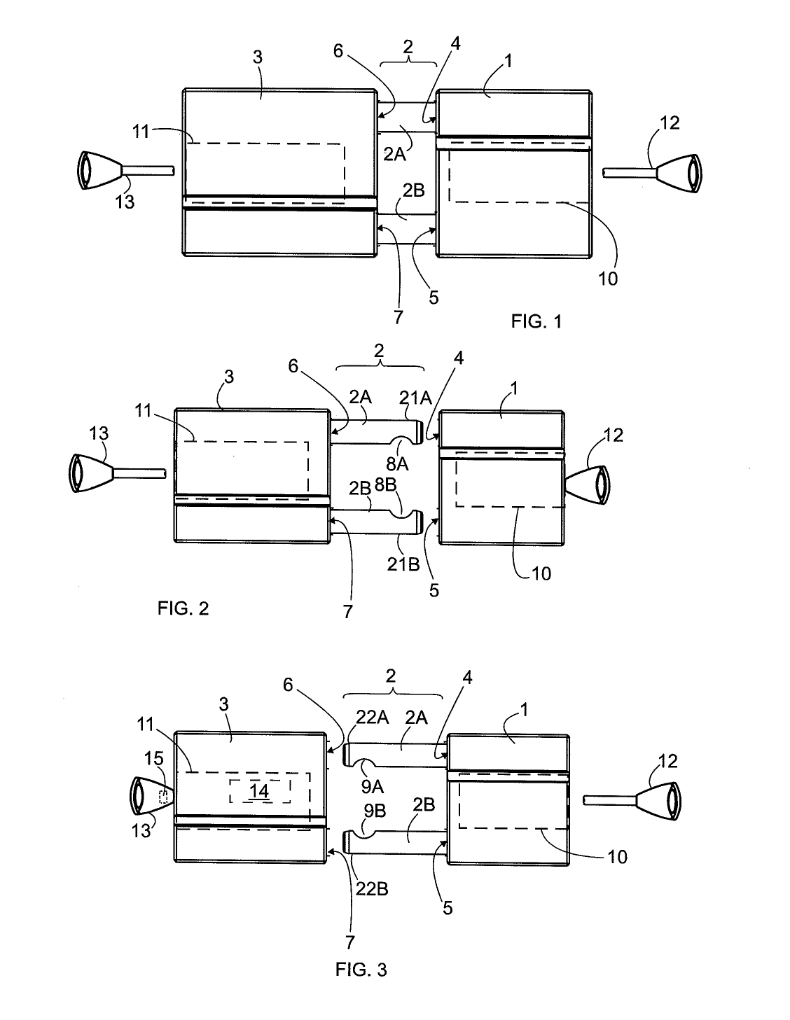

FIG. 1 shows an example of a padlock according to the invention. The lock arrangement shown in the figure comprises a body portion 1 and a shackle portion 2. The body portion has two holes 4, 5 for locking the shackle portion into the body portion. As can be observed, the shackle portion 2 comprises two pins 2A, 2B, having a first end 21A, 21B and a second end 22A, 22B. In both of the ends of the pins is a locking groove 8A, 8B, 9A, 9B. The first ends 21A, 21B of the pins are arranged to be locked into the holes 4, 5 of the body portion 1. The lock arrangement comprises also a second body portion 3 with another two holes 7, 8, into which the second ends 22A, 22B of the pins are arranged to be locked. Both body portions, i.e. the bodies, have a lock cylinder 10, 11 to be used with a key, using which the pins 2A, 2B can be locked into the bodies as well as released from the bodies. The first ends 21A, 21B of the pins can be seen in FIG. 2, when the (first) body 1 is open and the pins are out of the holes 4, 5. The second ends 22A, 22B of the pins can be seen in FIG. 3, when the second body 3 is open and the pins are out of the holes 6, 7.

FIG. 2 shows an exemplary situation, in which the (first) body 1 is guided with a key 12 into the unlocked state. In this case, the pins 2A, 2B of the shackle portion can be removed from the holes 4, 5 of the body, as is shown in FIG. 2. The pins are still locked into the second body 3. The second body is thus in the locked state. The locking between the pins 2A, 2B and the bodies 1, 3 occurs in a manner known per se by guiding the latch elements in the body into the locking grooves 8A, 8B, 9A, 9B of the pins and locking them into the grooves with the lock cylinder 10, 11. Releasing occurs correspondingly by guiding the lock cylinder with a key into the releasing position, wherein the latch elements are free to move away from the locking grooves. FIG. 3 shows a corresponding exemplary position, in which the second body 3 is guided with a key into the unlocked state and the body 1 is locked. The shape of the locking grooves shown in the figures can also be different, such as, for example, square or triangular, if the latch elements of the body 1, 3 are implemented as suitable for this kind of grooves.

A lock arrangement according to the invention provides a greater diversity of use than previously with known padlocks. There can be two users or user groups. It is possible that two different user groups x and y require access to a given common area, which is locked by a padlock, but the members of user group x may not have access to other areas of user group y and vice versa. The area used in common by the groups can be, for example, a common outdoor storage. In this case, the members of user group x can use the key of the first body of a padlock according to the invention and the members of user group y the key of the second body of the padlock.

It is also possible that the first body 1 and its key 12 are normally used and the second body 3 and its key 13 are used only in exceptional circumstances, such as, for example, if the key that is normally in use is lost. The key 13 of the second body 3 can thus be, for example, in the use of service/security personnel.

FIG. 3 shows also one possible embodiment, in which the second body 3 comprises an electric locking arrangement 14. The body has thus a tumbler arrangement to be opened electronically. If one or the other body of the lock arrangement (in this example, the second body 3) comprises an electronic locking arrangement 14, which is to be opened with a key 13 comprising an electronic code 15, it is common that a battery in the key or in the body loses its charge, wherein the key 12 of the second (in this example, thus the first) body 1 is a backup key for these types of situations. A body can also fail for a variety of reasons, wherein the other body functions as a backup body. The lock arrangement can thus also be used during the time, when the failed body portion has not yet been repaired or replaced.

There exist different types of lock cylinders, so the type of the lock cylinder 10 of the first body portion 1 can be different from the type of the lock cylinder 11 of the second body portion 3. As was already said above, one body can comprise an electronic locking system and the other body again a purely mechanical locking arrangement. Both bodies can, of course, comprise mechanical lock cylinders, or the lock cylinders of both bodies can comprise an electronic locking arrangement.

In order that the body portions would be to be used with different keys, i.e. the first body cannot be opened with the key of the second body and vice versa, the code of the lock cylinder 10 of the first body portion is different from the code of the lock cylinder 11 of the second body. The code means a combination known per se formed by the tumblers of the lock, wherein the lock is in the unlocked state. In this case, the lock is to be opened with such a key, which has a combination corresponding to the tumblers.

In light of the examples presented above, it is obvious that an embodiment according to the invention can be provided by many various solutions.

1. A lock arrangement, comprising a body portion (1) and a shackle portion (2), which body portion has two holes (4, 5) for locking the shackle portion into the body portion, characterized in that the shackle portion (2) comprises two pins (2A, 2B), having a first end (21A, 21B) and a second end (22A, 22B), and both of the ends (21A, 21B, 22A, 22B) of which pins have a locking groove (8A, 8B, 9A, 9B), which first ends (21A, 21B) are arranged to be locked into the holes (4, 5) of the body portion, and which lock arrangement further comprises a second body portion (3) with another two holes (6, 7), into which the second ends (22A, 22B) of the pins are arranged to be locked.

2. A lock arrangement according to claim 1, characterized in that both body portions (1, 3) comprise a lock cylinder (10, 11) used with a key for locking and releasing the pins (2A, 2B).

3. A lock arrangement according to claim 2, characterized in that the second lock cylinder (11) comprises an electronic locking arrangement (14).

4. A lock arrangement according to claim 2, characterized in that the type of the lock cylinder (10) of the first body portion (1) is different from the type of the lock cylinder (11) of the second body portion (3).

5. A lock arrangement according to claim 2, characterized in that the code of the lock cylinder (10) of the first body portion is different from the code of the lock cylinder (11) of the second body portion.
